(19) United States
(12) Patent Application Publication
(10) Pub. No.: US 2002/0188571 A1
(43) Pub. Date: Dec. 12, 2002

(54) Methods and systems for rapid messaging communications to a message receipt box (MRB)

(75) Inventor: Michael James Pilgrim, San Antonio, TX (US)

Correspondence Address: Michael James Pilgrim, 25134 Summit Creek, San Antonio, TX, 78258, US

(73) Assignee: EZ Notice, LLC

(21) Appl. No.: 10/127,468

(22) Filed: Apr. 23, 2002

Related U.S. Application Data
(60) Provisional application No. 60/285,761, filed on Apr. 24, 2001.

(51) Int. Cl. G06F 17/60

(52) U.S. Cl. 705/59

(57) ABSTRACT

This invention relates to methods and systems for rapid messaging communications to a message receipt box (MRB) integrated with a proprietary visual display box (VDB), or another operating communications system in which content messages are sent to selected recipients from a central station, and the corresponding messages are displayed on the message receipt box(es) where an alarm notification system may be present for the recipient when a message is present and an alarm notification system for the sender once the message has been read. This invention relates to a business use of VDB, alone, and in concert with other communications technologies (e.g., computer, pager, phone), both wired and wireless technology, and both software and/or hardware that integrate MRB with the sending system(s). This invention is one that expands on current use and motives of those technologies in the context of their specific use to disseminate information to the message receipt box(es) of various types of permanent or temporary residenes, and to business work site recipients. The latter aspect of the invention relates to sites that can include military and health care facilities, laboratories and testing facilities, or any multi-room or multi-component business entity which is aided with facilitated communications through MRB technology systems.

### CROSS-REFERENCE TO RELATED APPLICATIONS

This is a utility patent application that follows on Provisional Patent No. 60/285,761 The Inventor is Michael James Pilgrim with an address at 25134 Summit Creek, San Antonio, Tex. 78258.

### STATEMENT REGARDING FEDERALLY SPONSORED RESEARCH OR DEVELOPMENT

No parts of this product's development included research sponsored by any government agency.

### REFERENCE TO A SEQUENCE LISTING, A TABLE, OR A COMPUTER PROGRAM LISTING COMPACT DISC APPENDIX

Not applicable

### BACKGROUND OF THE INVENTION

Communications systems between central offices of residence units of a variety of types (Table 1) have inefficient or lacking systems for communications with residents. This is particularly true for apartment complexes, which often depend on runners who post notes on the doors or in mailboxes to inform or warn the residents of impending actions from repairs to emergencies or pending eviction. Although they may also depend on individual messages through the US mail, through fixed or mobile phone systems, or via communications through on-site intercoms, computers or televisions, it is common to post an individual to wait for a resident when direct communications are needed. This is expensive and inefficient.

TABLE 1
Some Residence and Work Site(s) that Will Benefit from On-Site MRBs

| | |
|---|---|
| Apartments | Assisted Residence Living Units |
| Condominiums | Nursing Homes |
| Hotels | Animal Housing Facilities |
| Motels | Laboratories |
| Dormitories | Test Centers |
| Hospitals | Military (Temporary or Permanent Housing) |

In many cases, there are government requirements and security issues regarding communications, but compliance can be difficult, notes can be lost, and many man-hours can be spent in non-productive work waiting for residents, or disseminating notices that often have no associated assurance of receipt. This is true of all types of resident housing, including those where the resident may have some type of health problem or medical need.

In the case of military and other government agency residences, housing, and work sites, said communications are also important components of national security.

This invention of a Message Receiver Box (MRB) relates to the development of combined hardware-software solutions to the communications problem described, and is also a business model of how the MRB facilitates effective communications in residence and work sites. It has high utility and thus meets such a requirement according to patent law.

The invention includes the development and use of a unique visual display component (VDC) as an integral or optional hardware component of a complete hardware-software communications system.

However, commercially available visual display and communications systems may be placed in customized MRB housing units with software linkages to the central management office or location, as another rendition of the invention.

The invention overcomes the specific requirement to turn on any machine, be it a phone, FAX, computer, television, PDA or other separate communication system since this invention is a system that is installed in the residence unit and is dedicated to that residence unit and the resident's needs.

The MRB is integrated, as appropriate, with software to allow simultaneous communications to multiple residence units or to a selected single unit, where said communications are secure and may allow a 2-way digital dialog; with options for audio and visual communications, various alarm and security system options, and use of credit or debit cards to pay for services.

Many solutions to digital and telecommunications needs have become commonplace for one-way, two-way and distributed communications. These include phones, pagers, personal digital assistants (PDAs; also referred to as “palm devices”), computers, televisions and radios.

This invention relates to the use of hardware, and integrated hardware-software solutions for easy dissemination of communications notices to apartment complexes and other residence or work-site organizations needing a communications solution.

Patents in the Field Patent searches were conducted using the Internet. Listed below is a set of patents (copies enclosed) selected as being most relevant to the invention. The novelty search included patents classified in Classes 725, subclass 78.

| U.S. Pat. No. | Patentee | Issue Date |
|---|---|---|
| 4,528,667 | Fruhauf | 7-9-1985 |
| 5,389,963 | Lepley et al. | 2-14-1995 |
| 5,565,908 | Abmad | 10-15-1996 |
| 5,970,386 | Williams | 10-19-1999 |
| 6,092,102 | Wagner | 7-18-2000 |
| 6,157,814 | Hymel et al. | 12-5-2000 |

There is an abundance of prior art in the field, but the novelty of the invention refers to the methods of use and the overall proposed features and options of the MRB and VDB to receive information at all times and to be used for communications (through a software-hardware interface) from a central site to individual residence areas or work sites; these are unique and novel and thus it is non-obvious to those knowledgeable in the art.

Key differences relate to the software and hardware solutions that are combined in an innovative use and multiple options in design, and in the business model derived.

### BRIEF SUMMARY OF THE INVENTION

This discovery optimizes methods for use of combined hardware and software solutions to facilitate communications and is a preferred method for information distribution to various types of residences and work sites.

The invention refers to hardware solutions, including use of new types of housing (the MRB Holder) for existing hardware and communications as one rendition of the invention;

It describes a unique visual display component architecture and the additional and optional features (FIG. 3) that create a unique and multi-functional communication tool.

Furthermore, it describes the communications approach as novel business model of very high utility.

Even further, it indicates that the applications and approach are non-obvious integrated applications even to those skilled in the art.

Another object of the invention is to provide a means for communicating in a 2-way fashion, which includes response from the recipient and a variety of optional component to the device.

These and other objects and features of the invention will be apparent from the following description.

The method and invention disclosed herein are novel business and personal use methods. The use of The MRB and the VDC components individually, or in concert, with or without the numerous indicated options can improve the quality of life for those sending or receiving the messages and thus has a high benefit of providing service, as well as safety and compliance to regulatory needs.

In the case of hospitals or nursing homes, the applications extend to health and welfare beyond simple messaging as the communications can include patient care.

The specific methods and drawings set forth herein are purely illustrative and those skilled in the art may determine other modifications and variations of these procedures. Such other modifications and variations are included within the scope of the claims listed below.

### BRIEF DESCRIPTION OF THE SEVERAL VIEWS OF THE DRAWING

FIG. 1 is an example of the MRB Holder to Accommodate Newly Designed Visual Display Component or Other Current or New Technologies Used as the Communication Vehicle

FIG. 2 is the preferred Rendition of the Visual Display Component of the Message Receipt Box

FIG. 3 shows some additional and Optional Features of the VDC and the MRB.

### DETAILED DESCRIPTION OF THE INVENTION

This invention is a system and business method by which message receipt box(es) [MRBs] receive messages from a central transmitter station via software and other communications tools integrated according to the specified needs of the user at the transmitter station and MRB points of use.

The MRBs are designed as versatile wall or door unit(s) mounted as a fixed and/or mobile communications apparatus conveniently located for the user, such as next to the entry/exit way of a residence or business.

However, the unit does not necessarily have to be mounted. The unit can be stand alone or be built into or attached to the wall, door, or entryway and/or use existing technology, such as a pager, palm device, computer, or other communications devices along with the MRB holding device.

The MRBs may consist of a wall holder for existing message receivers such as wireless pagers or it may consist of two or more separate or integrated Visual Display Boxes, one for received messages, and the other for advertisements or other types of secondary messages, which can be viewed at the leisure of the MRB user.

The holding device can be made of any material and be of any shape, form, color, size, weight, or artistic rendition. It will be constructed so that electricity (with a possible battery back up), batteries, or other energy sources may power the communication apparatus.

The MRBs may be electronically or software integrated with a property management system, a security system, a phone system, or other communicator using newly developed proprietary software alone, alone, or upon integration with existing or modified software.

The MRBs can receive text messages with alarm systems indicating the presence of a message or receipt of a message. These may be audio (for example, beeping sound or voice) and/or visual (for example, blinking light) messages.

A button, touch screen, voice command or other method may be used to stop the alarming system and, if needed, alert the sender that the message has been received.

The box may also have the same capabilities of current technologies, such as the ability to send messages via e-mail, voice, or touch screen, web surfing or web scraping, store information and/or word processing.

The invention has applications in both the commercial and residential sectors since communication through the MRBs is simple via various communications modes, for example, wired or wireless formats, and this will be expanded for the specific use described herein by software designed for the specific communication intent.

The MRBs will facilitate receiving messages, in an easy-to-use instant and ready access, because users can immediately read their messages upon site entry, rather than listen to them via answering machine/call notes or searching e-mail, which entails having a computer and internet access, and turning the machines on.

The device can range in size and capability from the size and limited utility of a small pager to a computer to a touch screen device, or to a larger wall unit.

It may also become integrated with other household and commercial communication and electronic devices, such as security systems, telephones (mobile and land line), answering machines, caller ID, televisions, stereos, pagers, computers, palm devices, fax machines, security systems, intercoms, and/or printers.

It could be mounted or built on, or in, a wall or door, in a secured box, mounting device, encasing device, or holding device or other materials, located inside or outside of the recipient's residence or commercial site.

The unit can have human recognition capabilities, such as fingerprints, face or retina recognition, voice recognition, and other methods for secure use by an individual or entity.

The MRBs could also be used to pay for services, including one's bills, when properly integrated with a payment device system.

A particular use for the invention is to facilitate communications while reducing short-term and long-term costs for delivering notices. As specific use examples, apartment complexes, hotels, multi-residence units such as military units, nursing homes, hospitals, and office tenants, or multi-office businesses would be sites where such MRBs and integrated software solutions would use the invention.

### Drawings and Figures

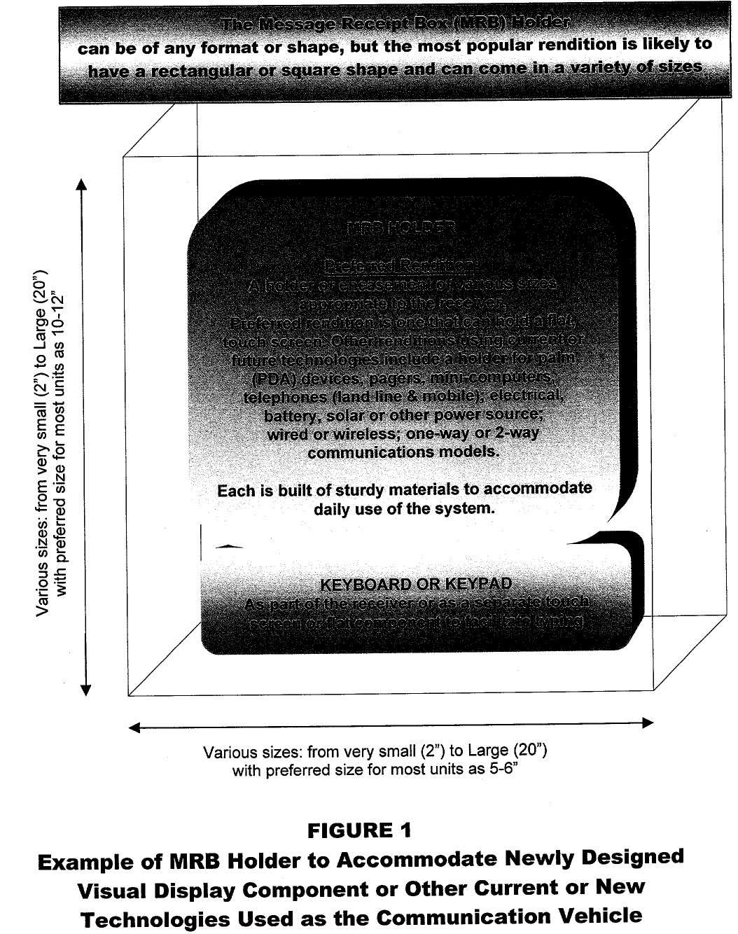

FIG. 1: Example of MRB Holder to Accommodate Newly Designed Visual Display Component(s) or Other Current or New Technologies Used as the Communication Vehicle

In reference to FIG. 1, the encasing device, or MRB holder, is to be newly developed according to the indicated specifications of the new visual display box or other hardware, or is developed for current technologies such as a pager, palm (PDA) devices , computers, telephones (mobiles and land lines), or MRBs. The encasing device can be of any color, shape, form, size, material, or artistic rendition, but is likely to have a rectangular or square shape and be flat to an entry wall. The type of technology, its purpose, and whether or not it will be a holder for new or current technologies will determine the details of the physical appearance of the box. The new or current technology to be the source for the visual display component (VDC) may be inserted from the top or any side of the box, with the box built to specifically accommodate the VDC. It may have a keypad or keyboard which would be flat or could stick out of the box in order facilitate typing. In another rendition, the preferred technology may have a touch screen or voice activated capabilities.

Preferred Rendition:

A holder or encasement of various sizes appropriate to the receiver is a rendition. The preferred rendition is one that can hold a flat, touch screen expected to range in size (2″ to 20″ width and 2″ to 20″ height, with preferred size expected to be about 5 to 6″ wide×10 to 12″ height. Other renditions using current or future technologies include a holder for palm (PDA) devices, pagers, mini-computers, telephones (land line and mobile); electrical, battery, solar or other power source; wired or wireless connections; one-way or 2-way communications models. Each is built of sturdy materials to accommodate daily use of the system.

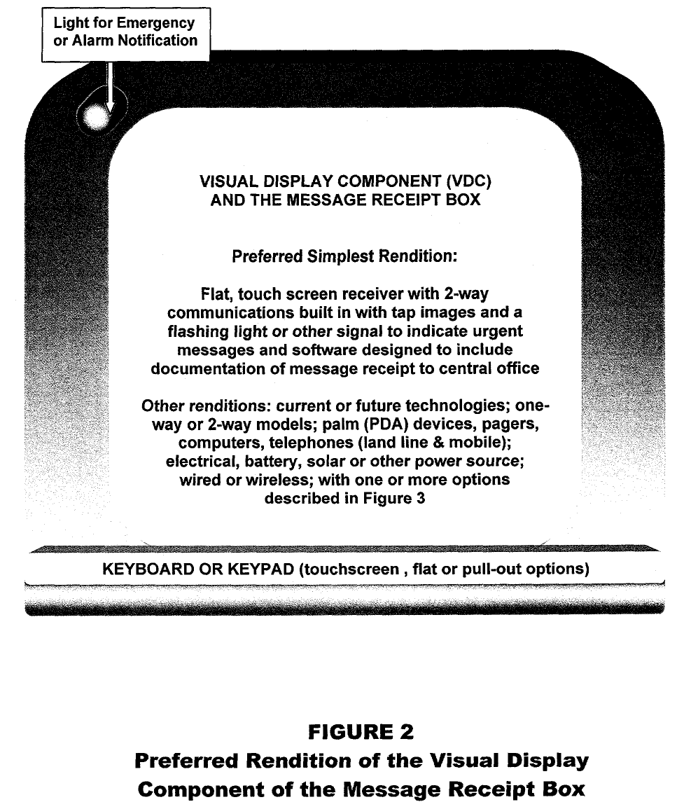

FIG. 2: Preferred Rendition of the Visual Display Component (VDC) of the Message Receipt Box

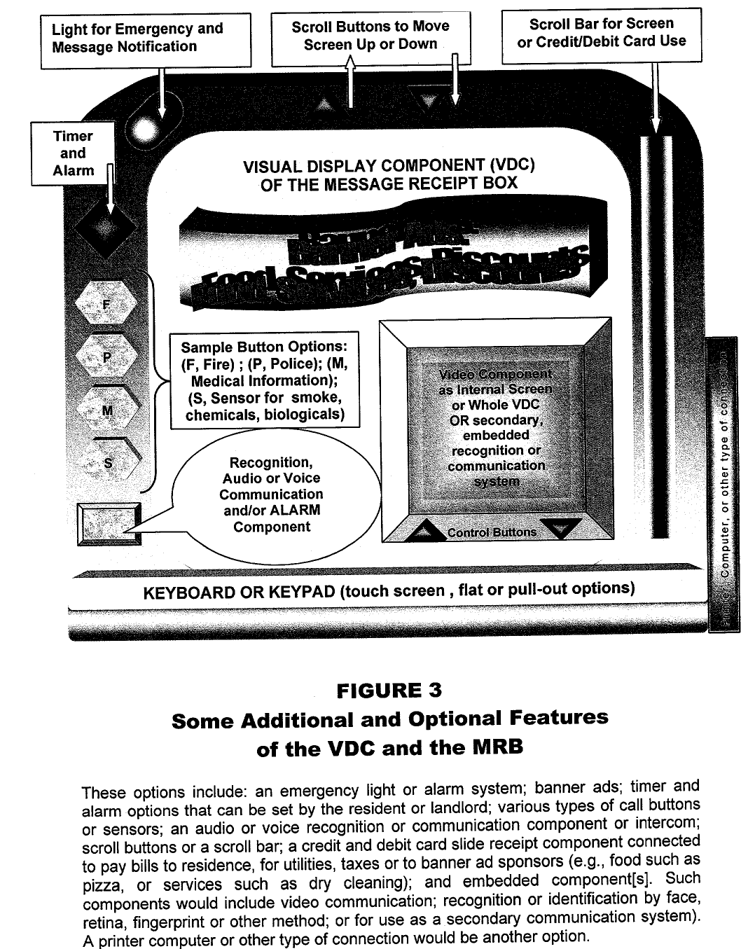

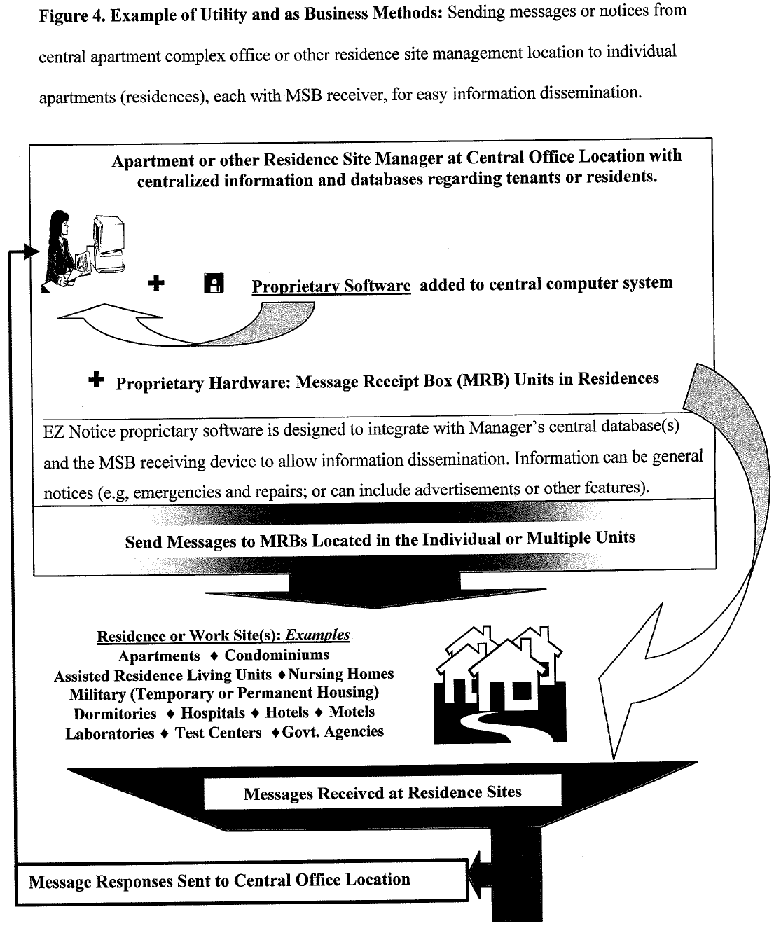

In reference to FIG. 2, the visual display component can be of any color, shape, form, size, material, or artistic rendition. FIG. 2 shows a rendition of the VDC which is newly developed receiver technologies, or, as another rendtition, it can be an adaptation of current technologies such as a flat screen pad or similar receiving device, palm devices, computers, telephones (mobiles and land lines), pagers, or MRBs. It can have a keyboard or keypad with touch sceen, flat, or pull-out options as an integrated 2-way or response system. The use of the MRB, cost options, and inclusion of options (e.g., as described in FIG. 3) will be components that discern the model to be used for a particular application and thus the specific physical appearance. The VDC MRB may be mounted in a variety of ways. It may be secured be snapping it in, screwed or nailed in, attached with velcro, taped in, strapped in, held by a cord, and other materials and methods for holding and/or mounting current and future communications devices. This may include connection to an electrical source or may be run by battery power, solar, or other power as an energy source. Two-way communications are the preferred embodiment although one-way systems with a message receipt function to notify the office of a message pick-up is the simplest rendition.

FIG. 3: Some Additional and Optional Features of the VDC and MRB

In reference to FIG. 3, the MRB can be of any color, shape, form, size, material, or artistic rendition. The Visual Display Box (VDB) can also be of any color, shape, form, size, material, or artistic renditon. The VDB can be have text messaging, voice messages, a touch screen, and/or printed paper messages. The VDB can include the Keypad, the Alarm Notification System, and/or the Scroll Bar. Yet, the basic models do not need to have any of the above mentioned features, that is, the Keypad, Scroll Bar, or Alarm Notification System. These options include: an emergency light or alarm system; banner ads; timer and alarm options that can be set by the resident or manager; various types of call buttons or sensors; an audio or voice recognition or communication component or intercom; scroll buttons or a scroll bar; a credit and/or debit card slide receipt component connected to pay bills to residence, for utilities, taxes or to banner ad sponsors (e.g., food such as pizza, or services such as dry cleaning); and embedded component[s]. Such components would include video communication; recognition or identification by face, retina, fingerprint or other method; or for use as a secondary communication system). A printer computer or other type of connection would be another option.

FIG. 4: Example of Utility and as a Business Model.

In reference to FIG. 4, sending messages or notices from the central apartment complex or other residence or work site management location goes to individual or multiple MRBs at the residences or work sites depending on the software and hardware configurations. This facilitates easy and consistent information dissemination. In the preferred rendition the messages are 2-way and include responses to the manager.

With the additonal options noted in FIG. 3, the manager not only has an efficient communication system but additional benefits with regard to safety, government compliance and other issues of daily importance to managers who need to efficiently contact their residents or work site units. An additonal benefit may come via potential sources of revenue from commissions or other payment for services or products from the vendors using the banner ads or with on-site use of credit or debit cards. The communication system allows indicating when repair, pest control or other services are needed at the site location with the receiver; to announce social or other events; and numerous other communications about a multitude of services. With a 2-way communication system the MRB site can report problems and emergencies to a central dispatcher or manager. As a result of the innovative technologies and their applications in a variety of residence or work site settings, such as apartments, condominiums, assisted residence living places, nursing homes, military temporary or permanent housing or work sites, dormitories, hospitals, hotels, motels, laboratories, test centers, and government agencies, to name some examples, leads to the overall benefits of cost-savings through improved efficiency and better management.

What is claimed is:

1. A communication system comprising of a transmitter station and plural receivers,
said station receives messages from a central transmitter station via software and/or other communications tools;
said station may be designed as a versatile wall or door unit(s) mounted as a fixed and/or mobile communications apparatus conveniently located for the user;
said station may be built into or attached to the wall, door, or entry-way and/or use existing technology, such as a pager, palm device, or computer along with the MRB holding device;
said station may be a wall holder for existing message receivers such as wireless pagers or it may consist of two or more separate or integrated Visual Display Boxes (VDBs);
said station may be made of any material and be of any shape, form, color, size, material, or artistic rendition;
said station may be constructed so that electricity (with a possible battery back up), batteries, or other energy sources may power the fixed communication apparatus;
said station having means to receive text messages with either audio (beeping sound or voice) or visual (blinking light) alarming systems when messages are present or both of the alarming methods or neither;
said station having means to stop the alarming system and if needed alert the sender of the message that it has been received;
said station may also have the same capabilities of current technologies;
said station may also become integrated with other household and commercial communication and electronic devices;
said station having means of human recognition capabilities, such as fingerprints, face, retina, or voice recognition, hair follicles, identification cards and/or keys, and other methods for secure use by an individual;
said station having means to pay bills;
said station may have means to send alphanumeric messages to either one, several, or all of the stationary receivers through a visual display box;
said station having means to send messages to both commercial and residential stationary receivers;
said station can be of any shape, size, form, color, design, weight, material and/or artistic rendition;
said station having means for visual and/or audio alarm notification when a message is sent and retrieved;
said station and receivers can be either stationary, mobile, or both;
said station can be mounted, built into or attached to the wall, door, or entry-way and/or use existing technology, such as a pager, palm device, or computer along with the MRB holding device;
said station may be mounted or built on or in a wall or door, in a secured box, mounting device, encasing device, or holding device inside or outside of the recipient's residence or commercial site.

2. In the system of claim 1, the software is integrated according to the specified needs of the user at the transmitter station and MRB points of use.

3. In the system of claim 1, the Visual Display Box for alphanumeric messages can be one or many of varying sizes.

4. In the system of claim 1, the receivers' primary purpose is one of notification for individuals or entities with the receivers. A specific system is apartment tenant notification. Apartment complex personnel are responsible for various notifications to their tenants. By law, every apartment must receive notifications when someone will be entering their apartment, when new policies or procedures are implemented, and general notification concerning the well being of the property. The communication system comprised of MRB to hardware and/or software will allow instant notification to all residents or work site units from the transmitter station to the receivers.

5. In the system of claim 2, the communication system is not limited to notification purposes. It can include a means for advertising. Additionally, the communication system is not limited to apartment complexes, but may include other types of multi-unit dwellings or multi-unit work sites at the same or connected locations, as civilian or as military sites, permanent or temporary.

6. In the system of claim 2, newly developed software that is compatible with existing pager software and compatible with existing apartment personnel software for means of tracking and recording retrieved notifications.

7. In the system of claim 3, the Visual Display Box or Boxes, with their built-in or optional features, can be used for notification purposes, messages from sources other than the transmitter station, advertising, and other communication devices.

8. In the system of claim 1, the receivers can be of similarity to pagers, palm devices, or computers, a combination of all three, and/or other communication devices.

9. In the system of claim 1, a button, touch screen, voice command or other method may be used to stop the alarming system.

10. In the system of claim 1, the features of the current technologies include the ability to send messages via e-mail, voice, or touch screen, web surfing or web scraping, store information and/or word processing, and/or other current and future technologies and may include connections to printers or other systems for communication or documentation.

11. In the system of claim 1, the household and commercial communication and electronic devices may include uniquely designed VDCs or MRBs alone, or with connections to telephones, answering machines, caller ID, televisions, stereos, pagers, computers, palm pilots, fax machines, and/or printers.

12. In the system of claim 1, the receiver's primary purpose is one of notification for individuals or entities with receivers in temporary or short-term living quarters, such as hotels, motels, inns, residence suites, or other managed properties.

13. In the system of claim 1, the receiver's primary purpose is one of notification for individuals or entities with receivers in medical facilities, including hospitals, nursing homes, rehabilitation facilities, and other medical facilities where instant messaging would be advantageous.

14. In the system of claim 1, the receiver's primary purpose is one of notification for individuals or entities with receivers in federal living quarters, such as military living quarters or other managed facilities.

15. In the system of claim 1, the receiver's primary purpose is one of notification for individuals or entities with receivers in managed offices, warehouses, retail, or business parks, and other business facilities where messaging from a central station to the managed properties is desirable.

16. In the system of claim 1, the receiver's primary purpose is one of notification for individuals or entities with receivers in any managed facilities not mentioned in the above claims.

17. In the system of claim 1, additional and optional features can be part of the visual display component, or the receiver box, or the holder. Such features may include, but are not limited to an emergency light or alarm system; banner ads; timer and alarm options that can be set by the resident or landlord; various types of call buttons or sensors; an audio or voice recognition or communication component or intercom; scroll buttons or a scroll bar; a credit and debit card slide receipt component connected to pay bills to residence, for utilities, taxes or to banner ad sponsors (e.g., food such as pizza, or services such as dry cleaning); and embedded component[s], Such components would include video communication; recognition or identification by face, retina, fingerprint or other method; or for use as a secondary communication system).

18. Optional features in 17 combined with other claims 1-16 provide a business model and multi-functional communications unit. For example, the business model allows additional potential revenue from the point of service payments, the banner ads, or other features to the managers or information distributors. Features such as banner ads bring optional discount opportunities for food and services to the recipient.

19. The utility of the system features defined in claims 1-17 convey the new business model shown in FIG. 4, which is a management tool combining site-specific software solutions with the hardware at various types of residence or work sites.

20. The new business model defined in claims 1-19, whereby security is increased when recognition software-hardware options are part of the MSB, safety is increased with integration to emergency buttons, and other benefits and sources of revenue as percent commissions can come to the manager from the recipient's use of the MRB to pay for services or utilities or from the companies paying for the banner ads.
